(19) United States
(12) Patent Application Publication
(10) Pub. No.: US 2014/0317452 A1
(43) Pub. Date: Oct. 23, 2014

(54) ERROR DETECTING APPARATUS, PROGRAM AND METHOD

(71) Applicant: Toshio Tonouchi, Tokyo (JP)

(72) Inventor: Toshio Tonouchi, Tokyo (JP)

(73) Assignee: NEC CORPORATION, Minato-ku, Tokyo (JP)

(21) Appl. No.: 14/351,748

(22) PCT Filed: Oct. 16, 2012
(86) PCT No.: PCT/JP2012/077172

§ 371 Date: Apr. 14, 2014

(30) Foreign Application Priority Data
Oct. 18, 2011 (JP) 2011-229042

(51) Int. Cl. G06F 11/36

(52) U.S. Cl. CPC G06F 11/3604
USPC 714/38.1

(57) ABSTRACT

An error detecting apparatus includes: an execution history storing unit to store a first execution history which is an execution history of a first program, and a second execution history which is an execution history of a second program changed from said first program; a flow comparing means for extracting positions, which are determined on the basis of positions at which a difference between number of executions of a predetermined instruction to number of executions of said first program, and number of executions of an instruction corresponding to said predetermined instruction to number of executions of said second program is not smaller than a predetermined value, from said first execution history and said second execution history; and a cause position restricting means for outputting cause position information which indicates a preceding position form said position of said second program.

### TECHNICAL FIELD

The present invention relates to an error detecting apparatus, a program and a method.

### BACKGROUND ART

When a program is modified due to upgrading software or the like, there may be some cases that a mismatch or a bug is caused at a position other than the modified position, and consequently degradation that quality becomes decreased is caused. An example of a system which detects the above-mentioned degradation is disclosed in patent documents 1 to 4.

According to A system described in the patent document 1, the system executes a program-before-improvement and a program-after-improvement, and stores a result of executing the program-before-improvement, and its journal in a DB (DataBase)-before-improvement, and a journal-before-improvement respectively. Furthermore, the system stores a result of executing the program-after-improvement, and its journal in a DB (DataBase)-after-improvement, and a journal-after-improvement. The system compares the DB-before-improvement and the journal-before-improvement, and the DB-after-improvement and the journal-after-improvement respectively, and judges whether an inconsistent data item name is included in an improvement item content DB. In the case that the inconsistent data item name is included in the improvement item content DB, an alert is issued, and in the case that the inconsistent data item name is not included, it is indicated that an error is caused. Furthermore, the system outputs a key of DB, the data item name before improving the program and the data item name after improving the program, and contents before improving the program and contents after improving the program to a degradation judgment result file.

According to a method described in the patent document 2, a modification object extracting and processing unit compares a source-code-before-modification and a source-code-after-modification, and extracts lines which are different each other in these source codes. By analyzing the source code under a base folder on the basis of the extraction result, an influenced object is detected to specify an influence pattern, and then review information for preventing generation of degradation is created.

According to a method described in the patent document 3, an operation at a time when executing a member function of a generated object is traced, and a history of the operation per the object is collected, and a corresponding position in the executed source file, and number of the executions are indicated per the object on the basis of the collected data.

According to an apparatus described in the patent document 4, execution dependence relation information which includes a control dependence relation and a data dependence relation is extracted at each time of executing a program, and the control dependence relation and the data dependence relation which are needed for estimating a cause of an error are extracted with reference to the execution dependence relation information.

### CITATION LIST

### Patent Document

PTL 1: Japanese Patent Application Laid-Open Publication No. 2005-276040

PTL 2: Japanese Patent Application Laid-Open Publication No. 2007-199800

PTL 3: Japanese Patent Application Laid-Open Publication No. 1999-212822

PTL 4: Japanese Patent Application Laid-Open Publication No. 1994-175884

### SUMMARY OF INVENTION

However, the above-mentioned system or the like has a problem that it is impossible to identify a portion of the program which causes the degradation. It is necessary that a designer searches for a portion of the program which should be modified, since the portion which causes the degradation is not identified even if the system detects the degradation.

An error detecting apparatus according to the present invention includes an execution history storing means for storing a first execution history which is an execution history of a first program, and a second execution history which is an execution history of a second program changed from the first program, a flow comparing means for extracting positions, which are determined on the basis of positions at which a difference between number of executions of a predetermined instruction to number of executions of the first program, and number of executions of an instruction corresponding to the predetermined instruction to number of executions of the second program is not smaller than a predetermined value, from the first execution history and the second execution history, and a cause position restricting means for outputting cause position information which indicates a preceding position form the position of the second program.

An error detecting program according to the present invention includes An error detecting program to make a computer, which includes an execution history storing means for storing a first execution history which is an execution history of a first program, and to store a second execution history which is an execution history of a second program changed from the first program, execute: a flow comparing step to extract positions, which are determined on the basis of positions at which a difference between number of executions of a predetermined instruction to number of executions of the first program, and number of executions of an instruction corresponding to the predetermined instruction to number of executions of the second program is not smaller than a predetermined value, from the first execution history and the second execution history, and a cause position restricting step to output cause position information which indicates a preceding position form the position of the second program.

An error detecting method according to the present invention includes storing a first execution history which is an execution history of a first program, and a second execution history which is an execution history of a second program changed from the first program, extracting positions, which are determined on the basis of positions at which a difference between number of executions of a predetermined instruction to number of executions of the first program, and number of executions of an instruction corresponding to the predetermined instruction to number of executions of the second program is not smaller than a predetermined value, from the first execution history and the second execution history, and outputting cause position information which indicates a preceding position form the position of the second program.

Accordingly, an object of the present invention is to provide an error detecting apparatus, a program and a method which are able to restrict a cause position at which an error is caused in a program.

### BRIEF DESCRIPTION OF DRAWINGS

FIG. 1 is a block diagram showing an example of a configuration according to a first exemplary embodiment.

FIG. 2 is a block diagram showing an example of a configuration of an error detecting unit 1100.

FIG. 3 is a flow chart showing an example of an operation according to the first exemplary embodiment.

FIG. 4 is a flow chart showing an example of an operation according to the first exemplary embodiment.

FIG. 5 is a diagram showing an example of a program-before-update.

FIG. 6 is a diagram showing an example of a program-after-update.

FIG. 7 is a diagram showing an example of the program-after-update which indicates an influenced area due to the update.

FIG. 8 is a diagram showing an example of a program in which a probe is inserted.

FIG. 9 is a diagram showing examples of control flows which a log-before-update and a log-after-update include.

FIG. 10 is a diagram showing an example which indicates that a degradation causing position is restricted on the basis of the control flow.

FIG. 11 is a diagram showing an example of a program-after-update in which the degradation causing position is restricted.

FIG. 12 is a block diagram showing an example of a configuration according to a second exemplary embodiment.

FIG. 13 is a flow chart showing an example of an operation according to the second exemplary embodiment.

FIG. 14 is a block diagram showing an example of a configuration according to a third exemplary embodiment.

### DESCRIPTION OF EMBODIMENTS

Hereinafter, an exemplary embodiment according to the present invention will be described with reference to a drawing. In all drawings, a common component is assigned a common code, and description on the common component is omitted properly.

Here, each unit, which is included in an apparatus or the like according to each exemplary embodiment, includes hardware such as a logic circuit. Moreover, each unit includes a control unit for a computer, a memory, a program which is loaded in the memory, a storage unit such as a hard disk or the like which stores the program, and an interface which is used for connecting with a network. Or, each unit may be realized by any combination of hardware and software. As far as there is no note, a realization method and an apparatus are not limited.

Moreover, the control unit includes CPU (Central Processing Unit) or the like, and controls a whole of the apparatus or the like by operating OS (Operating System). Furthermore, the control unit reads a program and data from a recording medium which is mounted on a driving apparatus, and stores the program and the data in the memory, and carries out various processes according to the program and the data.

The recording medium is, for example, an optical disc, a flexible disc, a magnetic optical disc, an external hard disk, a semiconductor memory or the like, and stores a computer program so as to be able to be read by the computer. Moreover, the computer program may be downloaded from an external computer which is not shown in the figure and which is connected with a communication network.

### Exemplary Embodiment 1

Next, a first exemplary embodiment of the present invention will be described in detail with reference to a drawing.

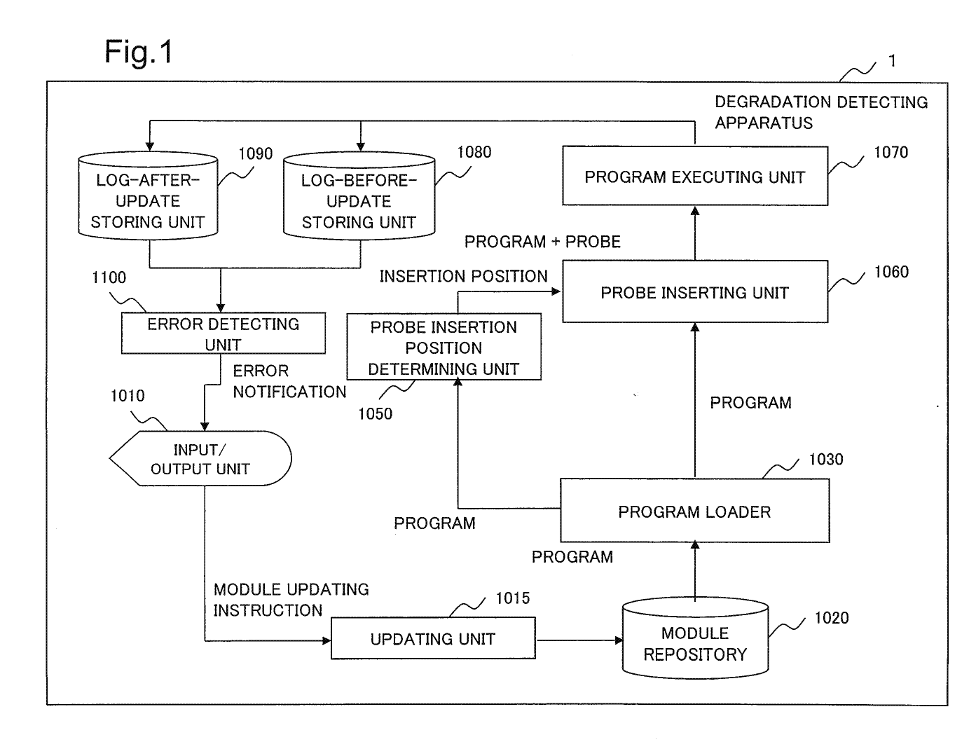

A configuration of a degradation detecting apparatus 1 according to the exemplary embodiment is shown in FIG. 1. The degradation detecting apparatus 1 includes an input/output unit 1010, an updating unit 1015, a module repository 1020, a program loader 1030, a probe insertion position determining unit 1050, a probe inserting unit 1060, a program executing unit 1070, a log-before-update storing unit 1080, a log-after-update storing unit 1090, and an error detecting unit 1100.

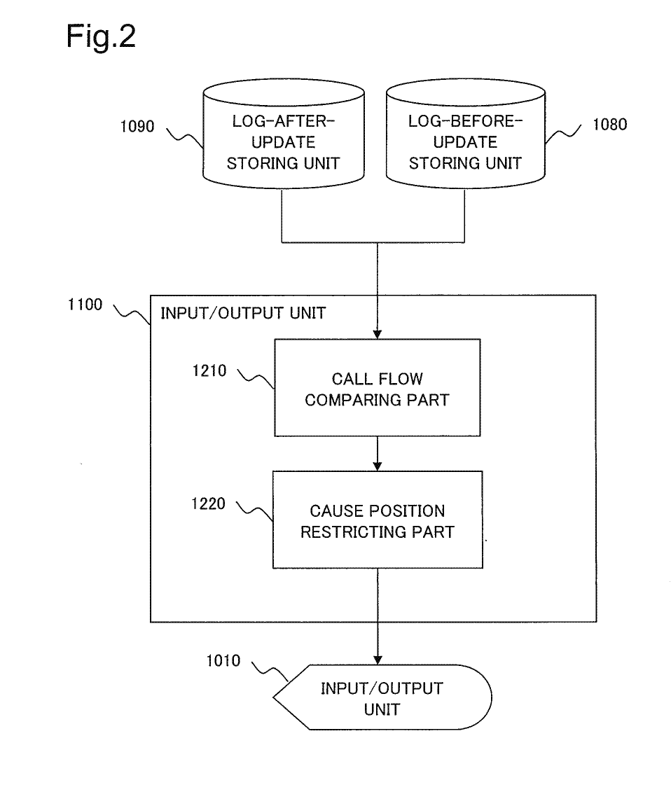

Moreover, as shown in FIG. 2, the error detecting unit 1100 includes a control flow comparing part 1210 and a cause position restricting part 1220.

The input/output unit 1010 includes an input means which receives an instruction for module revision (update) from a designer or the like, and an output means which indicates a result of analyzing degradation.

The updating unit 1015 copies a program (program-before-update), which is stored in the module repository 1020, according to an instruction provided by the input/output unit 1010, and revises (update) the copy. The updating unit 1015 stores the revised program (program-after-update) in the module repository 1020.

The module repository 1020 stores the program (program-before-update and program-after-update), a library and a related module.

The program loader 1030 loads the program and the module for executing the program from the module repository 1020.

The probe insertion position determining unit 1050 determines a position, at which it is possible to measure an amount of flow on a control flow, in the program-before-update and the program-after-update.

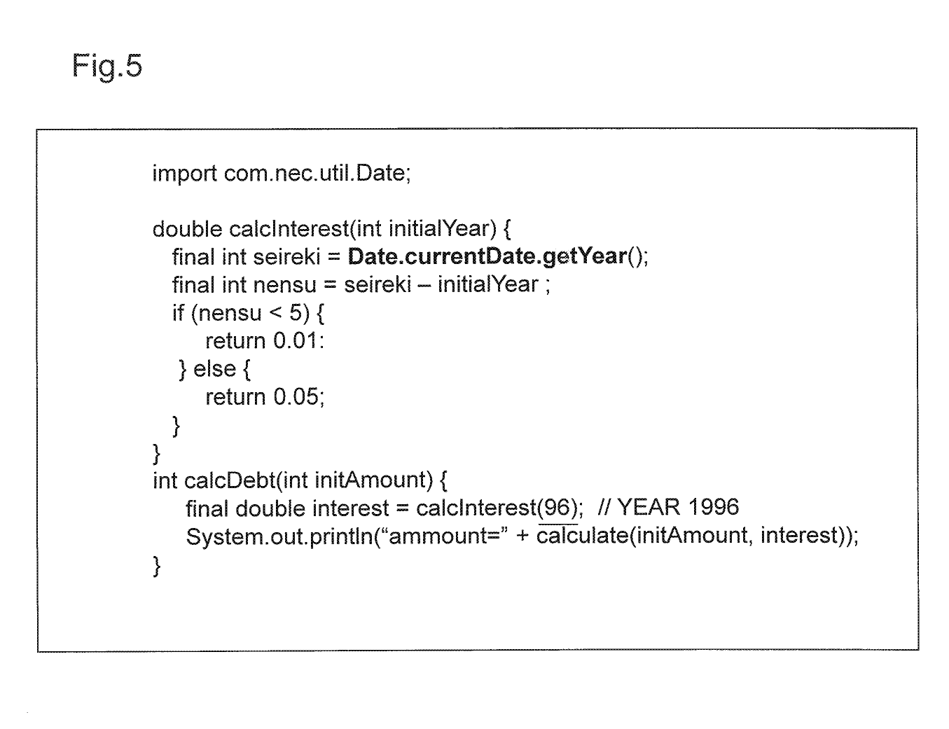

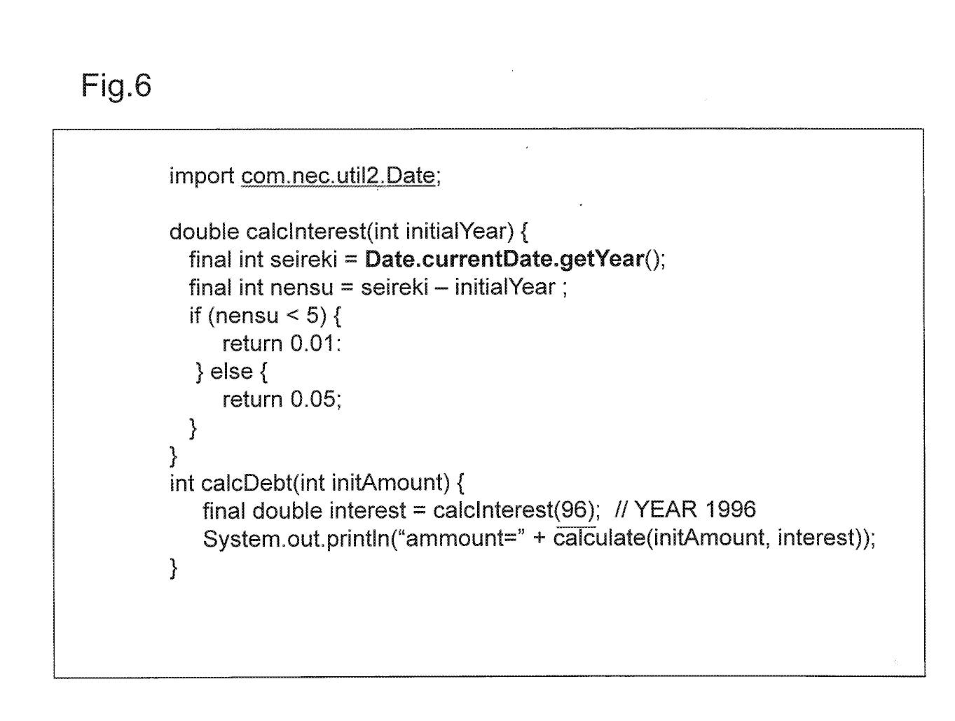

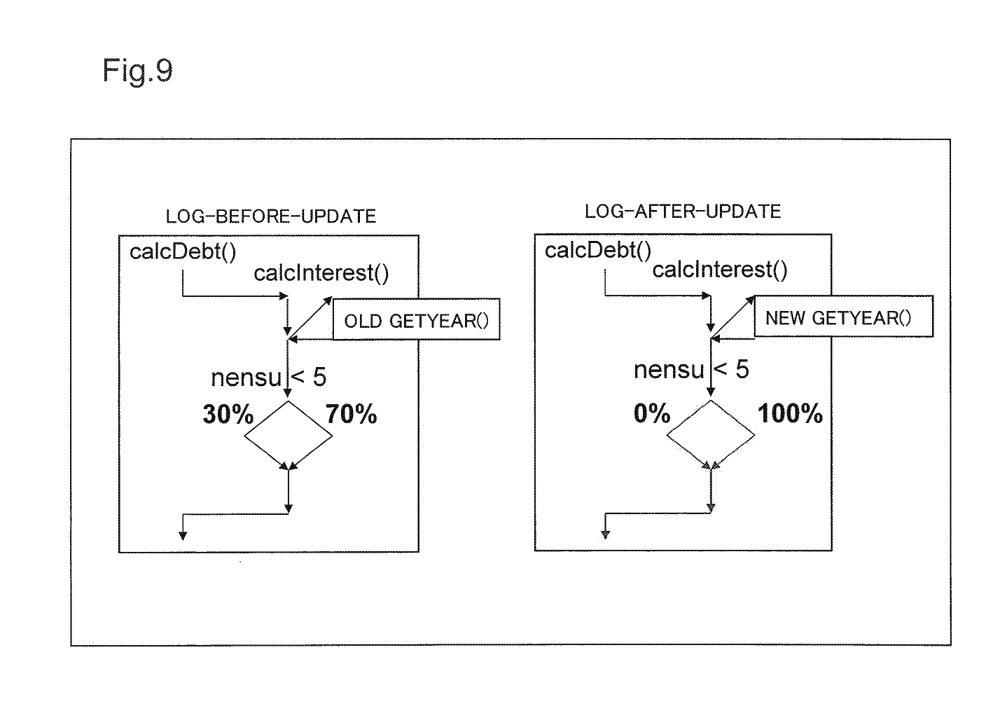

Here, the control flow means traces of a result of executing a program. For example, FIG. 9 shows examples of control flows which show traces of executing programs shown in FIGS. 5 and 6. FIG. 9 shows that the calcDebt function calls the calcInterest function, and the calcInterest function calls the getYear function, and a conditional branch exists in the calcInterest function. As mentioned above, a node which is included in the control flow is corresponding to a predetermined program sentence (conditional branch sentence, loop sentence (while sentence or the like), a sentence for calling a subroutine, and an exceptional receiving portion (catch sentence or the like)). Moreover, a process which is carried out by the node included in the control flow is denoted as a route (path or side) which connects a node with another node. That is, the side connects a predetermined program sentence (instruction sentence), and another predetermined program sentence (instruction sentence) which has a possibility to be carried out next.

Moreover, when the program is executed, number of times (execution number) of passing a path actually out of all routes (path), each of which has the possibility to pass (to be carried out) on the control flow, is called an amount of flow of the path. For example, as shown in FIG. 9, the calcInterest function includes a conditional branch, and a condition can determine a path, which should be passed actually, out of a left path and a right path. Then, for example, number of times of passing the left path is called an amount of flow which passes the left path.

The position, at which it is possible to measure an amount of flow on the control flow, in the program-before-update and the program-after-update, is corresponding to a predetermined position, which is next to a position describing an instruction sentence and which has a possibility to generate a process other than execution of an instruction sentence, such as a head position of a subroutine, head positions of a then portion and an else portion of a conditional branch sentence, a head position of a loop (loop sentence or the like), an exceptional receiving portion (catch sentence or the like) or the like. It is assumed in the exemplary embodiment that the probe insertion position determining unit 1050 defines that the predetermined position, at which it is possible to measure an amount of flow on the control flow as mentioned above, is a probe inserting position. Here, a person may assign the same ID to positions, which are corresponding each other, in the program-before-update and the program-after-update, and may insert probes at the positions.

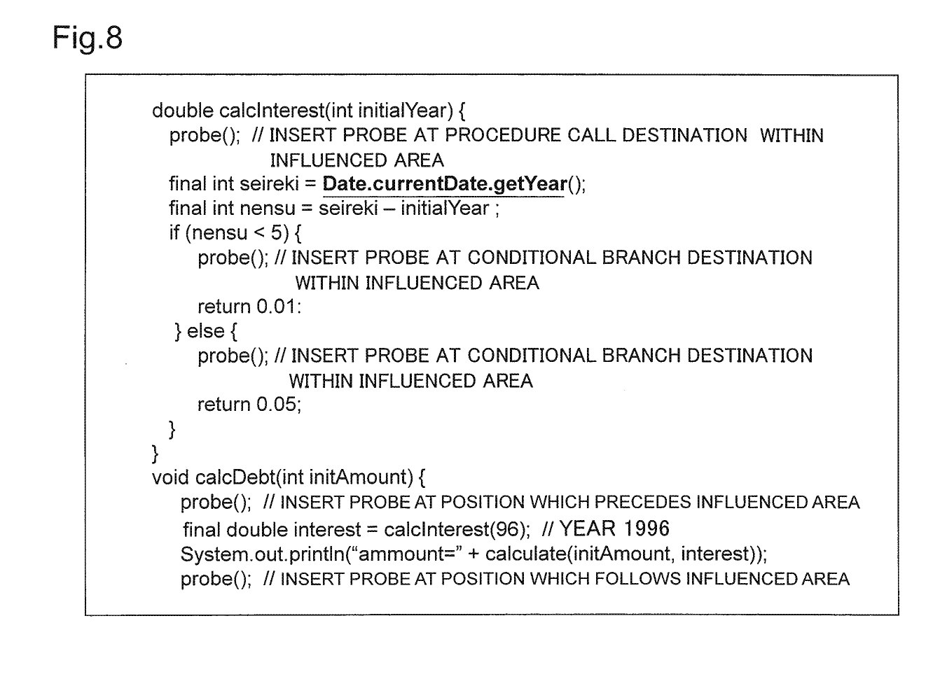

The probe inserting unit 1060 inserts the probe at the position which the probe insertion position determining unit 1050 determines. That is, the probe inserting unit 1060 inserts probe description (hereinafter, referred to as probe simply) at the predetermined position at which it is possible to measure an amount of flow on the control flow in the program-before-update and the program-after-update (refer to FIG. 8). In the case that an instruction, which is described at the position at which the probe is inserted, is carried out, the probe outputs an execution result (log) of an instruction which is described just before the position (or just after the position).

The program executing unit 1070 executes the program-before-update and the program-after-update.

The log-before-update storing unit 1080 and the log-after-update storing unit 1090 stores the logs which the probes, which are inserted in the program-before-update and the program-after-update, output respectively. The log-before-update storing unit 1080 stores the log which records an amount of flow (number of executions) per the path on the control flow of the program-before-update. The log-after-update storing unit 1090 stores the log which records an amount of flow (number of executions) per the path of the program-after-update.

The error detecting unit 1100 restricts a position of causing the degradation by comparing the log which is stored in the log-before-update storing unit 1080 (log-before-update), and the log which is stored in the log-after-update storing unit 1090 (log-after-update). Specifically, the error detecting unit 1100 includes the control flow comparing part 1210 and the cause position restricting part 1220 as shown in FIG. 2, and these parts operate as follows.

The control flow comparing part 1210 compares a ratio of amount of flow per the path on the control flow (ratio of number of executions of the path to number of all executions of the program) which is recorded in the log stored in the log-before-update storing unit 1080 (log-before-update), and a ratio of amount of flow per the path on the control flow which is recorded in the log stored in the log-after-update storing unit 1090 (log-after-update), and specifies positions at which a difference between the ratios of amount of flow is not smaller than a threshold value designated in advance. That is, on the basis of the log-before-update and the log-after-update, the control flow comparing part 1210 specifies positions at which a difference between a ratio of number of executions of a predetermined instruction to number of executions of the program-before-update, and a ratio of number of executions of an instruction corresponding to the predetermined instruction to number of executions of the program-after-update is not smaller than a predetermined value.

For example, a control flow of the log-before-update shown in the left side figure of FIG. 9 shows that a branch of an if sentence (nensu>5) has two paths. Here, it is assumed that, when the calcDebt function is carried out 100 times, number of times of passing through one path of the branch is 30, and number of times of passing through the other path of the branch is 70. In this case, a ratio of amount of flow through one path of the branch is 30%, and a ratio of amount of flow through the other path of the branch is 70%. On the other hand, a control flow of the log-after-update shown in the right side figure of FIG. 9 shows that a ratio of amount of flow through one path of a corresponding branch is 0%, and a ratio of amount of flow through the other path of the corresponding branch is 100%. That is, a difference between the execution ratio of amount of flow of the path on the control flow of the log-before-update, and the execution ratio of amount of flow of the corresponding path of the log-after-update is 30%. Then, it is assumed that a threshold value designated in advance is, for example, 20%. In this case, since the difference in the ratio of amount of flow of the path is not smaller than the threshold value, the control flow comparing part 1210 specifies a position of the branch (nensu>5) of the if sentence.

Moreover, it is assumed, for example, that each of the program-before-update and the program-after-update includes a loop sentence, and each program is executed 100 times, and number of executions of the loop sentence, which is a head of loop instruction stream on the control flow of the log-before-update, is 300 (300%), and number of executions of the corresponding loop sentence on the control flow of the log-after-update is 600 (600%). Then, a difference between the ratios of amount of flow (number of executions) of the paths corresponding each other is 300%. Moreover, it is assumed that a threshold value is 200%. In this case, since the difference in the ratio of amount of flow is not smaller than the threshold value, the control flow comparing part 1210 specifies a position at which the loop sentence is described.

Moreover, it is assumed, for example, that each of the program-before-update and the program-after-update includes a subroutine calling instruction, and each program is executed 100 times, and a subroutine A is called 50 times (50%) and a subroutine B is called 20 times (20%) on the control flow of the log-before-update. On the other hand, it is assumed that the subroutine A is called 20 times (20%), and the subroutine B is called 30 times (30%), and a subroutine C is called 50 times on the control flow of the log-after-update. In this case, a ratio of the number of executions of the subroutine is 30% in the case of the subroutine A, 10% in the case of the subroutine B, and 50% in the case of the subroutine C. Accordingly, in the case that a threshold value is 20%, the ratio of the number of executions exceeds the threshold value in the case of the subroutines A and C. Accordingly, the control flow comparing part 1210 specifies positions at which the subroutines A and C are described.

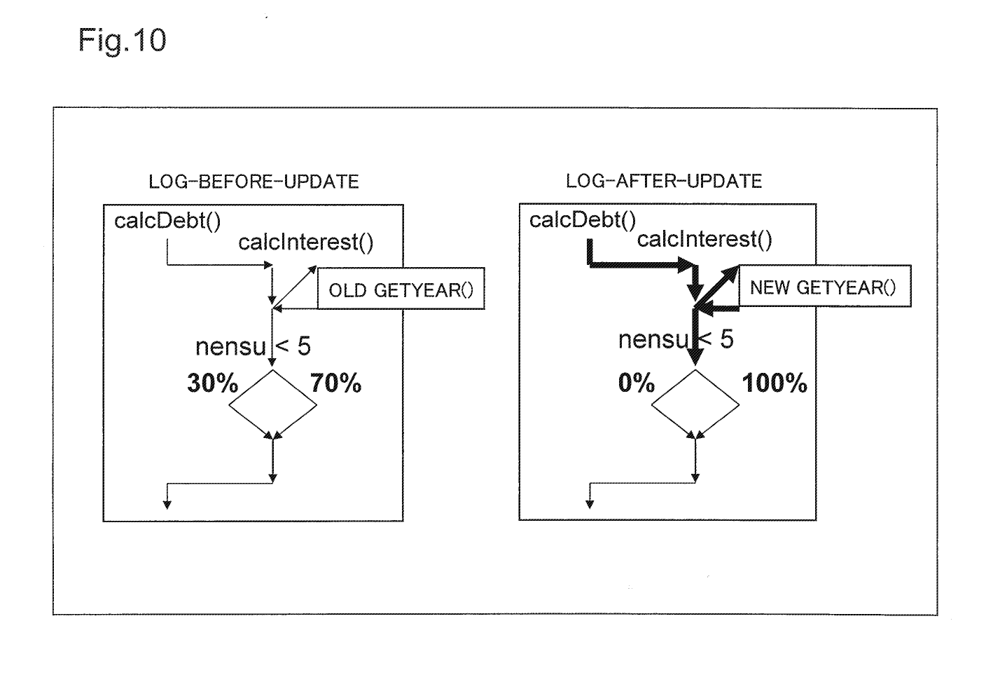

The cause position restricting part 1220 restricts a position, which precedes the path specified by the control flow comparing part 1210, on the control flow of the log-after-update as a problematic position which has a degradation generating cause (degradation causing position) (refer to a bold line shown in the right side figure of FIG. 10). Since the control flow has characteristics of sequence based on an order of the execution of the program, “position preceding a certain path” is a position which includes a path corresponding to an instruction preceding an instruction corresponding to the certain path.

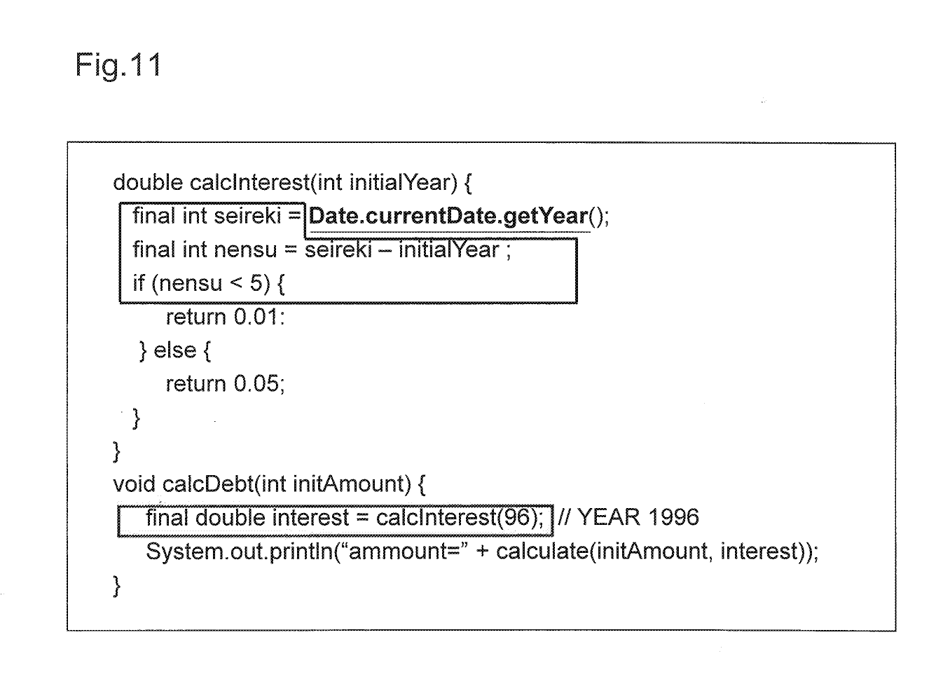

Moreover, the cause position restricting part 1220 restricts the degradation causing position on the program-after-update on the basis of correspondence between the control flow and the program-after-update (refer to FIG. 11 and a detail will be described in a second exemplary embodiment). Then, the cause position restricting part 1220 outputs information, which indicates the degradation causing position in the program-after-update, to the input/output unit 1010.

In the case of systems which have an identical utilization purpose, it can be assumed that a program-before-modification (program-before-update) and a program-after-modification (program-after-update) generate amounts of flow, which are almost equal, on the paths corresponding each other on the control flows corresponding each other. For this reason, in the case that the ratio of amount of flow of the path on the control flow in the program-before-modification, and the ratio of amount of flow of the corresponding path on the corresponding control flow in the program-after-modification are different large, there are a lot of possibilities that the degradation is caused. As mentioned above, by virtue of the operation of the cause position restricting part 1220, it is possible to restrict the degradation causing position.

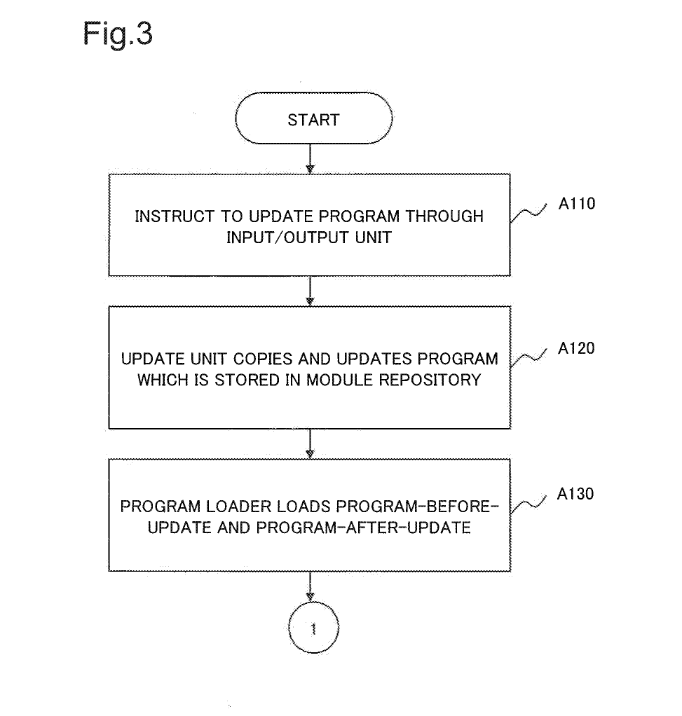

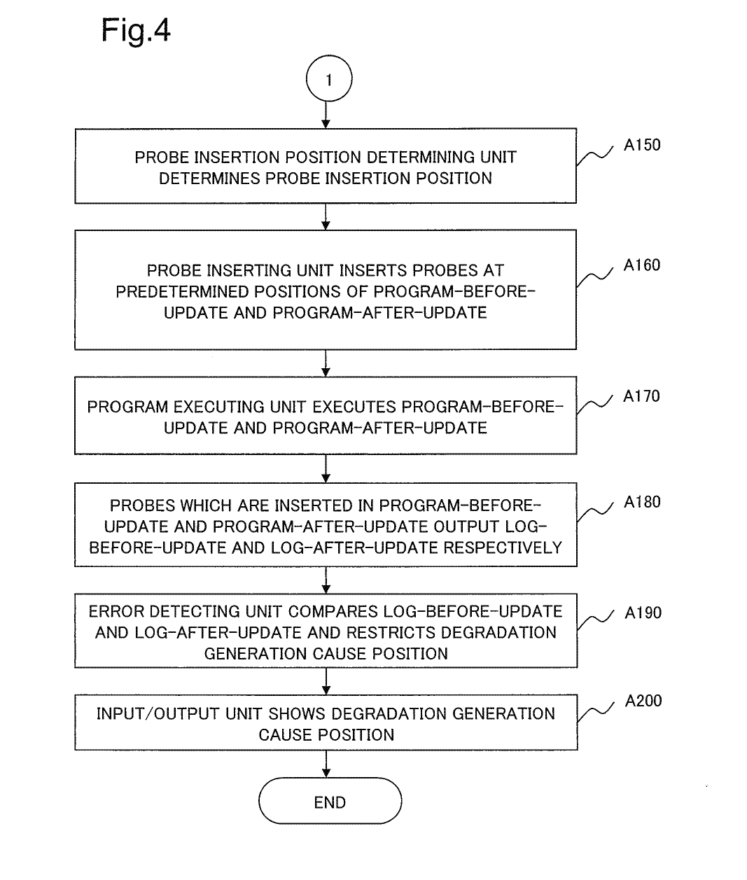

Next, a whole operation according to the exemplary embodiment will be described with reference to flowcharts shown in FIGS. 3 and 4.

First, a designer or the like instructs to update the program through the input/output unit 1010 (Step A110 in FIG. 3). The probe which has an ID in advance is inserted in the program.

Next, the updating unit 1015 copies the program (program-before-update) which is stored in the module repository 1020, and updates the copied program (Step A120). The updating unit 1015 stores the program-after-update in the module repository 1020.

Next, the program loader 1030 loads the program-before-update and the program-after-update from the module repository 1020 (Step A130).

Here, the program may not include the probe in advance, and the probe insertion position determining unit 1050 may determine the positions at which the probes are inserted in the program-before-update and the program-after-update (Step A150 of FIG. 4). According to the exemplary embodiment, the probe insertion position determining unit 1050 determines a predetermined position, at which it is possible to measure an amount of flow on the control flow, such as a head position of the subroutine, head positions of a then portion and an else portion of a conditional branch sentence, a head position of a loop sentence or the like as the probe insertion position. By the probe insertion position determining unit 1050's analyzing a program sentence, it is possible to specify the predetermined position where there is a possibility that a process, which is described at a position next to a position where an instruction is described on the program and which is not execution of an instruction sentence, is generated. For example, in the case that the probe insertion position determining unit 1050 finds an if sentence in the program, a branch exists at the position of the if sentence. As a result, it is possible to judge that the position of the if sentence is corresponding to the predetermined position. Accordingly, the probe insertion position determining unit 1050 determines that the probe should be inserted at the position. These positions may be designated by a designer or the like in advance.

In order that, in the following step, the error detecting unit 1100 will compare amounts of flow of the paths which are corresponding each other on the control flows of the log-before-update and the log-after-update, the probe insertion position determining unit 1050, for example, determines the probe insertion position on the program-after-update, and afterward determines that a predetermined position of the program-before-update, which is specified by the probe insertion position, is the probe insertion position. In order to determine the probe insertion position, for example, the probe insertion position determining unit 1050 may determine the probe insertion position with the existing method, for example, the method of assigning an ID (Identification) to the probe. Or, the probe insertion position determining unit 1050 may search the program-before-update for a position where there is description which is identical with description on a predetermined instruction (such as a head position of the conditional branch) specified by the probe insertion position of the program-after-update, and may determine that the position is the probe insertion position.

The probe inserting unit 1060 inserts the probes at the predetermined positions of the program-before-update and the program-after-update which the probe insertion position determining unit 1050 determines (Step A160).

Next, the program executing unit 1070 executes the program-before-update and the program-after-update (Step A170).

At this time, the probes, which are inserted in the program-before-update and the program-after-update, output the logs, which are the execution histories of the program-before-update and the program-after-update, to the log-before-update storing unit 1080 and the log-after-update storing unit 1090 respectively (Step A180).

Next, the error detecting unit 1100 compares the log-before-update which is stored in the log-before-update storing unit 1080, and the log-after-update which is stored in the log-after-update storing unit 1090, and restricts the degradation causing position as mentioned above (Step A190). The error detecting unit 1100 sends the restricted degradation causing position to the input/output unit 1010.

Finally, the input/output unit 1010 outputs the degradation causing position which is acquired from the error detecting unit 1100 (Step A200).

The degradation detecting apparatus 1 according to the exemplary embodiment has the configuration of comparing the logs, which record amounts of flow of the paths on the control flows of the program-before-update and the program-after-update, and restricting the positions, whose pattern of an amount of flow is quite different, as the degradation causing position. Therefore, according to the exemplary embodiment, it is possible to restrict the degradation causing position in the program.

According to the system which is described in the above-mentioned patent document, only input/output data of the system and the database, which are an inspection object, are an observation object. Then, according to the system which is described in the patent document, a case that an old system and a new system are set to be in the same execution state, and are provided with the same input date, and consequently do not output the same output data is detected as the case that there is a possibility of causing the degradation.

However, it is difficult except a time of program inspection to set the old and the new systems to be in the same state, and to provide the old and the new systems with the same input data. Therefore, according to the system described in the patent document, it is difficult to detect the degradation except the time of the program inspection.

On the other hand, according to the degradation detecting apparatus 1 according to the exemplary embodiment of the present invention, it is easy to detect the degradation even at a time of operation. The reason is that the degradation detecting apparatus 1 observes an internal state of the program, that is, observes the control flow, and specifies the degradation causing position.

### Exemplary Embodiment 2

Next, a second exemplary embodiment of the present invention will be described in detail with reference to a drawing. A common code is assigned to a common component in the first and the second exemplary embodiments, and description on the common component is omitted.

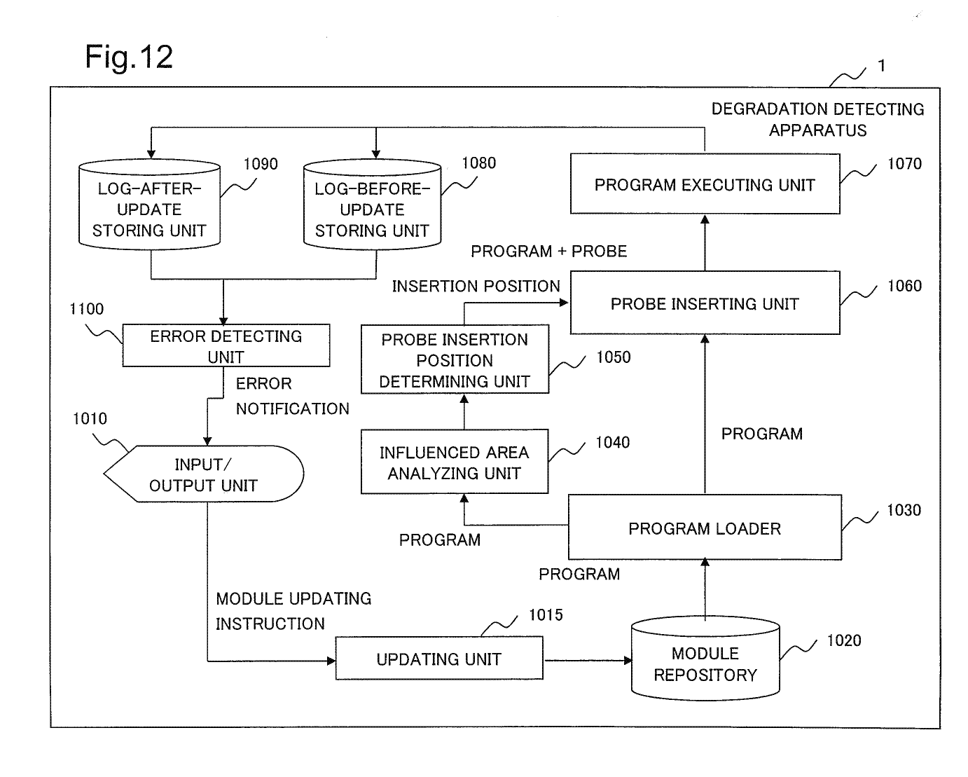

Referring to FIG. 12, the degradation detecting apparatus 1 according to the second exemplary embodiment is different from one according to the first exemplary embodiment in a point that the degradation detecting apparatus 1 according to the second exemplary embodiment includes an influenced area analyzing unit 1040. The influenced area analyzing unit 1040 estimates an influenced area indicating an area which an update module designated by the input/output unit 1010 causes influence in the program loaded by the program loader 1030. That is, the influenced area analyzing unit 1040 estimates the influenced area which is a portion depending on the update of the program. Detailed example will be described later.

Moreover, the probe insertion position determining unit 1050 according to the second exemplary embodiment is different from one according to the first exemplary embodiment in a point that the probe insertion position determining unit 1050 according to the second exemplary embodiment determines the probe insertion position within the influenced area which is estimated by the influenced area analyzing unit 1040. A specific example will be described later.

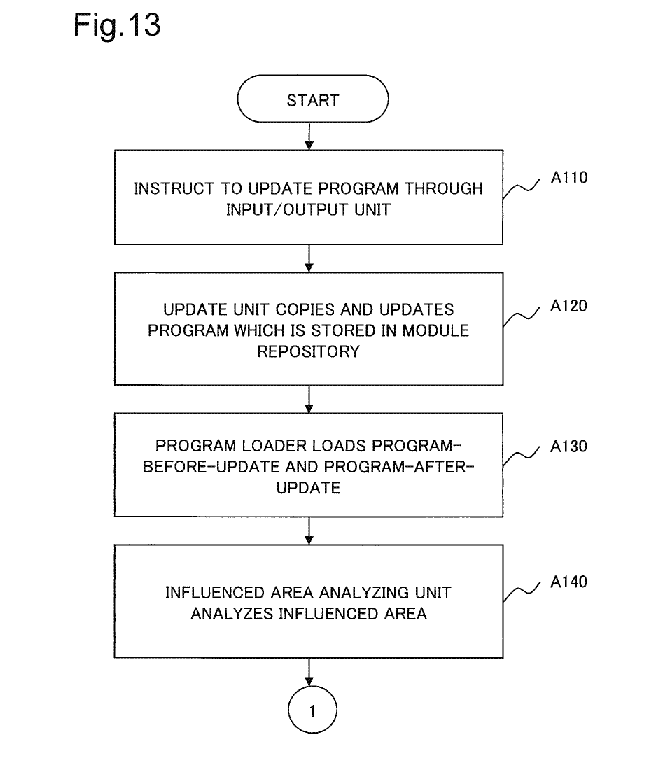

With reference to flowcharts shown in FIG. 13 and FIG. 4, a whole operation according to the exemplary embodiment will be described.

Steps A110 to A130 of FIG. 13 are the same as Steps A110 to A130 of FIG. 3. The flowchart shown in FIG. 13 is different from the flowchart according to the first exemplary embodiment in a point that the flowchart shown in FIG. 13 includes Step A140.

First, a designer or the like instructs to update the program through the input/output unit 1010 (Step A110 in FIG. 13). Next, the updating unit 1015 copies the program which is stored in the module repository 1020, and updates the copied program (Step A120). Then, the program loader 1030 loads the program-before-update and the program-after-update (Step A130). The above-mentioned processes are the same as ones according to the first exemplary embodiment.

Next, in the case that the program-before-update is updated to be the program-after-update, the influenced area analyzing unit 1040 analyzes a position, which is caused the influence due to the updated position, in the program, and estimates the area which is caused the influence (influenced area) (Step A140). For example, in the case that there is a dependent relation between a variable and another variable, program sentences or the like including these variables respectively have a possibility to be influenced each other. That is, the influenced area analyzing unit 1040 can find the influenced area by analyzing whether the dependent relation between the program sentences exists. The technology to find the influenced area in the program is called the program slice or the like and is well known. For example, the technology is well known by virtue of the following literature. Weiser, M.: “Program Slicing”, Proceedings of the Fifth International Conference on Software Engineering, pp. 439 449, 1981.

Next, the probe insertion position determining unit 1050 determines the position at which an amount of flow on the control flow is measured within the influenced area which the influenced area analyzing unit 1040 analyzes (Step A150 of FIG. 4).

Next, the probe inserting unit 1060 inserts the probes at the predetermined positions of the program-before-update and the program-after-update (Step A160). For example, the probe insertion position determining unit 1050 inserts the probe at a position in the program such as positions just preceding and just following the influenced area, a head position of a subroutine included in the influenced area, head positions of a then portion and an else portion of a conditional branch sentence included in the influenced area, a head position of a loop sentence included in the influenced area, and the like. These positions may be designated by a designer or the like in advance. By virtue of the above-mentioned configuration, it is possible for the degradation detecting apparatus 1 to restrict the degradation causing position within the influenced area. Here, in the case that the probe to which ID is assigned in advance is inserted in the program, Steps A150 and 160 are unnecessary similarly to the first exemplary embodiment.

Next, the program executing unit 1070 executes the program-before-update and the program-after-update (Step A170). The probes inserted in the program-before-update and the program-after-update output the logs to the log-before-update storing unit 1080 and the log-after-update storing unit 1090 respectively (Step A180).

Next, the error detecting unit 1100 compares the log-before-update and the log-after-update, and restricts the degradation causing position (Step A190). Finally, the input/output unit 1010 indicates the degradation causing position (Step A200). Here, while the probe inserting unit 1060 inserts the probe within the influenced area in Step A160 according to the above-mentioned description, the prove insertion position is not limited to the inside of the influence area. That is, the probe inserting unit 1060 may insert the probe also in the outside of the influenced area, and the error detecting unit 1100 may restrict the degradation causing position within the influenced area.

Next, an example of an operation of the exemplary embodiment will be described with exemplifying a case that a program shown in FIG. 5 is given as the program-before-update.

It is assumed that the program does not cope with the Y2K problem. That is, a library “Date.currentDate.getYear ( )” function returns “98” in the case that the current year is 1998, and returns “11” in the case that a designated year is 2011.

Then, in order to enable the program to be used in and after the year 2000, a designer replaces the “Date.currentDate.getYear ( )” function with a library which returns a year of the Christian era. That is, the designer replaces the library so that the “Date.currentDate.getYear ( )” function may return not “11” but “2011” if the current year is 2011.

However, if the library is replaced, a position which uses the library may be caused a bug. For example, according to an example in FIG. 5, if an underline part of “96”, which means the year1996, is not rewritten to “1996”, the degradation is caused.

Then, firstly, the designer instructs the updating unit 1015 through the input/output unit 1010 to replace the “Date.currentDate.getYear ( )” function, which is used in the program shown in FIG. 5, with a library which copes with the Y2K problem (Step A110 in FIG. 13).

Next, the updating unit 1015 copies a program which is stored in the module repository 1020, and updates the copied program by replacing “Date.currentDate.getYear ( )” with the library which copes with the Y2K problem (Step A120). That is, the updating unit 1015 replaces a library “com.nec.util.Date” with a library “com.nec.util2.Date” which copes with the Y2K problem as shown by an underline part in FIG. 6.

Furthermore, the program loader 1030 loads the program-before-update shown in FIG. 5 and the program-after-update shown in FIG. 6 (Step A130).

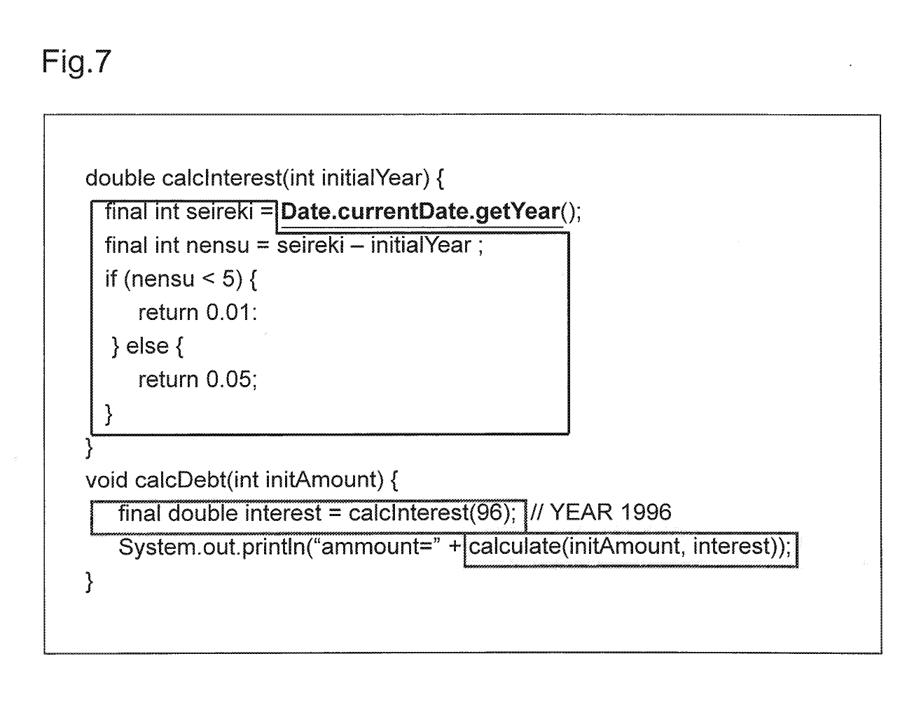

Next, the influenced area analyzing unit 1040 estimates the influenced area, which is caused the influence due to the update, in the program-after-update (Step A140). According to the example, the influenced area, which the influenced area analyzing unit 1040 estimates, is exemplified in FIG. 7. An area which is surrounded by a section in FIG. 7 is the influenced area. Since Date.currentDate.getYear ( ) is replaced in the example, a return value and a position of the program which uses the return value are corresponding to the influenced area.

Next, the probe insertion position determining unit 1050 inserts the probe at the predetermined position at which an amount of flow on the control flow can be specified within the influenced area which the influenced area analyzing unit 1040 estimates (Step A150).

FIG. 8 shows an example of inserting the probes in the program-before-update and the program-after-update. A portion, which indicates “probe ( )” shown in FIG. 8, is corresponding to the inserted probe.

The program executing unit 1070 executes the program-before-update and the program-after-update in which the probes are inserted (Step A170).

The probe which is inserted in the program-before-update and the probe which is inserted in the program-after-update output the log-before-update and the log-after-update to the log-before-update storing unit 1080 and the log-after-update storing unit 1090 respectively (Step A180).

A result of the log includes information equivalent to information shown in FIG. 9. A left side figure in FIG. 9 shows information which is included in the log (log-before-update) outputted by the program-before-update, and a right side figure shows information which is included in the log (log-after-update) outputted by the program-after-update.

Each figure in FIG. 9 indicates the control flow. That is, FIG. 9 shows that the calcDebt function calls the calcInterest function, and the calcInterest function calls the getYear function, and one conditional branch exists in the calcInterest function.

The error detecting unit 1100 measures the ratio of amount of flow per the path on the flow control. For example, in the case of the log-before-update, a path of a then portion of a conditional branch in the calcInterest function has an amount of flow of 30% out of a whole amount of flow, and a path of an else portion has an amount of flow of left 70%. On the other hand, in the case of the log-after-update, a path of a then portion has an amount of flow of 0%, and a path of an else portion has an amount of flow of 100%. This reason is as follows. That is, since the getYear function returns number of 4 digits such as 2011 or the like after the update, a difference between the number of 4 digits, and 96 which is a value of the initialYear variable is almost identical with the number of 4 digits in most cases. Therefore, a case of being not larger than 5 in the conditional branch does not exist.

The error detecting unit 1100 compares the log-before-update and the log-after-update, and restricts the degradation causing position (Step A190). That is, according to the example, the control flow comparing part 1210 compares the ratios of amount of flow of the paths corresponding each other on the control flows which the log-before-update and the log-after-update indicate. As a result, the control flow comparing part 1210 detects paths, whose difference in the ratio of amount of flow is not smaller than a designated threshold value, as the position at which there is a possibility that the degradation is caused.

In the case that the control flow comparing part 1210 judges that a position, at which there is a possibility that the degradation is caused, exists, the cause position restricting part 1220 traces back the control flow from a head position of a path whose difference in the ratio of amount of flow is not smaller than a threshold value, and restricts a position up to a head position of the influenced area as the degradation causing position.

In the case of an example shown in FIG. 10, the cause position restricting part 1220 restrict an area, which extends from a starting position of the influenced area within the calcDabt function up to an if sentence in the calcInterest function, as the degradation causing position. The position is corresponding to a position indicated by a bold line in the right side figure of FIG. 10 which shows the log-after-update.

Finally, the input/output unit 1010 indicates the degradation causing position in the updated program (Step A200). That is, the input/output unit 1010 shows a degradation generating position to a designer so as to distinguish a portion, which is surrounded with a section in FIG. 11 (portion which describes a program sentence and which is corresponding to the portion indicated by the bold line in the log-after-update shown in the right side figure of FIG. 10) from another portion. The designer finds “calcInterest (96)” by investigating the restricted area of the degradation generating position, and can change “calcInterest (96)” to “calcInterest (1996)” or the like at the position.

The degradation detecting apparatus 1 according to the exemplary embodiment has the configuration of comparing the logs, which record amounts of flow of the paths on the control flows of the program-before-update and the program-after-update, and restricting the position, whose pattern of amount of flow is quite different, as the degradation causing position. Therefore, according to the exemplary embodiment, it is possible to restrict the degradation causing position within the program.

Moreover, since the exemplary embodiment has the configuration that the influenced area analyzing unit 1040 restricts the influenced area due to the program update, and the probe insertion position determining unit 1050 inserts the probe within the area in the program, it is possible to restrict the problematic position inside the program with using the smallest number of the logs.

### Exemplary Embodiment 3

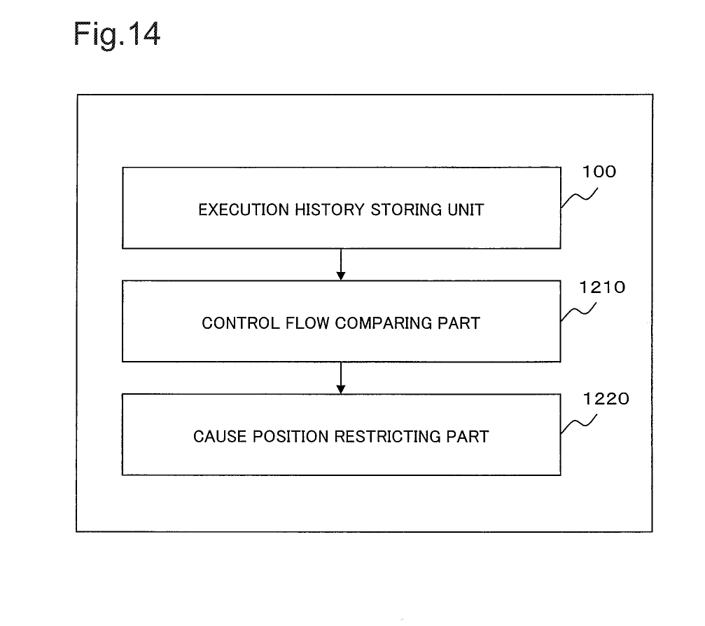

Next, a third exemplary embodiment of the present invention will be described with reference to a drawing. FIG. 14 is a diagram showing an example of a configuration of the degradation detecting apparatus 1 according to the exemplary embodiment. The degradation detecting apparatus 1 includes an execution history storing unit 100, the control flow comparing part 1210 and the cause position restricting part 1220.

The execution history storing unit 100 stores the log-before-update which is the execution history of the program-before-update, and the log-after-update which is the execution history of the program-after-update.

The control flow comparing part 1210 extracts positions, at which a difference between a ratio of number of executions of a predetermined instruction to number of executions of the program-before-update, and a ratio of number of executions of an instruction corresponding to the predetermined instruction to number of executions of the program-after-update is not smaller than a predetermined value, from the log-before-update and the log-after-update.

The cause position restricting part 1220 outputs information which indicates a preceding position from a position correspond to the position extracted by the control flow comparing part 1210 in the program-after-update.

While the degradation detected by comparing two programs of the old version and the new version is shown as an example in the above-mentioned exemplary embodiments 1 to 3, the present invention is not limited to the example. As far as a control flow of two programs is in an almost unchanged state, the present invention is applicable to two programs. For example, the present invention is applicable to objects of two programs, that is, a MySQL (registered trademark) based application and an ORACLE (registered trademark) based application in the field of the relational database.

According to the error detecting apparatus 1 according to the exemplary embodiment, it is possible to restrict the error causing position in the program.

While the present invention has been described with reference to the exemplary embodiment above, the present invention is not limited to the above-mentioned exemplary embodiment. It will be understood by those of ordinary skill in the art that various changes in form and details may be made therein without departing from the spirit and scope of the present invention as defined by the claims.

This application is based upon and claims the benefit of priority from Japanese Patent Application No. 2011-229042, filed on Oct. 18, 2011, the disclosure of which is incorporated herein in its entirety by reference.

### REFERENCE SIGNS LIST

1010 input/output unit
1015 updating unit
1020 module repository
1030 program loader
1040 influenced area analyzing unit
1050 probe insertion position determining unit
1060 probe inserting unit
1070 program executing unit
1080 log-before-update storing unit
1090 log-after-update storing unit
1100 error detecting unit
1210 control flow comparing part
1220 cause position restricting part

1. An error detecting apparatus, comprising:
an execution history storing unit to store a first execution history which is an execution history of a first program, and a second execution history which is an execution history of a second program changed from said first program;
a flow comparing means for extracting positions, which are determined on the basis of positions at which a difference between number of executions of a predetermined instruction to number of executions of said first program, and number of executions of an instruction corresponding to said predetermined instruction to number of executions of said second program is not smaller than a predetermined value, from said first execution history and said second execution history; and
a cause position restricting means for outputting cause position information which indicates a preceding position form said position of said second program.

2. The error detecting apparatus according to claim 1, further comprising:
an influenced area analyzing means for specifying an influenced area, which is a portion depending on said change, in said second program, wherein
said cause position restricting means outputs said cause position information within said influenced area.

3. The error detecting apparatus according to claim 1, wherein
said first execution history includes an execution history which indicates a branch destination of a branch instruction of said first program, and said second execution history includes an execution history which indicates a branch destination of a branch instruction of said second program, and wherein
said flow comparing means extracts positions where branch instructions, whose difference in number of executions of said predetermined instruction existing at either of branch destinations of each of said branch instructions, which are corresponding each other in said first execution history and said second execution history, is not smaller than a predetermined value, are described.

4. The error detecting apparatus according to claim 1, wherein
said first execution history includes an execution history of an instruction which exists in a loop of said first program, and said second execution history includes an execution history of an instruction which exists in a loop of said second program, and wherein
said flow comparing means extracts positions where loop instructions, whose difference in number of executions of said predetermined instruction existing in each of said loops which are corresponding each other in said first execution history and said second execution history is not smaller than a predetermined value, are described.

5. The error detecting apparatus according to claim 1, wherein
said first execution history includes an execution history of a subroutine calling instruction of said first program, and said second execution history includes an execution history of a subroutine calling instruction of said second program, and wherein
said flow comparing means extracts positions where subroutine calling instructions, whose difference in number of calling a different kind of subroutine according to said subroutine calling instructions which are corresponding each other in said first execution history and said second execution history, is not smaller than a predetermined value, are described.

6. A non-transitory computer-readable computer medium storing an error detecting program to make a computer, which includes an execution history storing unit to store a first execution history which is an execution history of a first program, and to store a second execution history which is an execution history of a second program changed from said first program, execute:
extract extracting positions, which are determined on the basis of positions at which a difference between number of executions of a predetermined instruction to number of executions of said first program, and number of executions of an instruction corresponding to said predetermined instruction to number of executions of said second program is not smaller than a predetermined value, from said first execution history and said second execution history; and
outputting cause position information which indicates a preceding position form said position of said second program.

7. A non-transitory computer-readable computer medium detecting program according to claim 6 to make said computer execute:
specifying an influenced area, which is a portion depending on said change, in said second program; and
outputting said cause position information within said influenced area.

8. An error detecting method, comprising:
storing a first execution history which is an execution history of a first program, and a second execution history which is an execution history of a second program changed from said first program;
extracting positions, which are determined on the basis of positions at which a difference between number of executions of a predetermined instruction to number of executions of said first program, and number of executions of an instruction corresponding to said predetermined instruction to number of executions of said second program is not smaller than a predetermined value, from said first execution history and said second execution history; and
outputting cause position information which indicates a preceding position form said position of said second program.

9. The error detecting method according to claim 8, further comprising:
specifying an influenced area, which is a portion depending on said change, in said second program; and
outputting said cause position information within said influenced area.
